(19) United States
(12) Patent Application Publication
(10) Pub. No.: US 2019/0085214 A1
(43) Pub. Date: Mar. 21, 2019

(54) FLEXIBLE, THERMALLY STABLE AND SIMULTANEOUSLY TRANSPARENT BIO-BASED FILM BASED ON POLY(LACTIC ACID), FORMULATION FOR PRODUCING THE FILM AND USE OF SAID FILM

(71) Applicant: TESA SE, Norderstedt (DE)

(72) Inventors: Kerstin KLINGEBERG, Hamburg (DE); Bernhard MÜSSIG, Seevetal (DE)

(21) Appl. No.: 15/526,935

(22) PCT Filed: Oct. 29, 2015
(86) PCT No.: PCT/EP2015/075101

§ 371 Date: May 15, 2017

(30) Foreign Application Priority Data
Nov. 18, 2014 (DE) 10 2014 223 470:0

(51) Int. Cl. C09J 7/25; C08L 67/04; C09J 7/38; C08J 5/18; C08K 5/00; C08K 5/11

(52) U.S. Cl. CPC C09J 7/255; C08L 67/04; C09J 7/38; C08J 5/18; C08K 5/0016; C08J 2367/04; C08K 5/11; C09J 2201/606; C09J 2203/334; C09J 2205/114; C08K 5/0083

(57) ABSTRACT

The invention relates to a bio-based film comprising a composition based on poly(lactic acid), said composition containing the following components: (a) at least one bio-based co-polymer based on at least one lactic acid derivative; (b) at least one plasticizer comprising at least one compound which contains at least one ester group, excluding dimeric and polymeric esters of lactic acid; (c) at least one nucleation agent; and (d) optional additives.

This application is a § 371 U.S. National stage of PCT International Patent Application No. PCT/EP2015/075101, filed Oct. 29, 2015, which claims foreign priority benefit of German Patent Application No. DE 10 2014 223 470.0, filed Nov. 18, 2014, the disclosures of each of which patent applications are incorporated herein by reference.

The present invention relates to a biobased film with improved properties such as thermal stability, degree of crystallization, softness and transparency, and also to its use as carrier for pressure-sensitive-adhesive sheet products such as cable tapes and cable-wrapping tapes. The invention further relates to a formulation A and a formulation B respectively comprising at least one polymer based on lactic acid, at least one plasticizer and at least one nucleating agent, and also to a process for the production of the film of the invention from at least one of the formulations A and B.

There are many known formulations using polylactic acid (PLA) and films based on polyesters comprising polylactic acid. However, the films produced from the formulations, or the known films, have insufficient thermal stability, which is extremely important inter alia for coating with an adhesive and for applications as carrier in adhesive tapes or in cable-wrapping tapes for the automobile sector. Inadequate softness in the known formulations has often been compensated by blending with a biodegradable polyester, for example polyethylene terephthalate (PET).

Softness of films based on polylactic acid (PLA) is achieved in the prior art (DE 10 2007 038 473 A1) inter alia by admixing long-chain plasticizers such as polyglycols, and thus reducing migration of the plasticizer. Other compositions (US 2009/0311511 A1) based on polylactic acid comprise organic compounds as nucleating agents, for example aliphatic carboxamides having at least one amide bond, preferably ethylenebiscarboxamide, in order to achieve thermal stability of three-dimensional moldings that can be produced therefrom.

Another relevant point when lactic acid and its derivatives are used as starting material for the production of polyesters is increased crystallization of the polylactic acid in this type of composition: US 2012/0184672 A1 describes a PLA resin composition with a Exhibit A plasticizer, in particular a carboxylic ester and, as additive, wax or a mineral filler such as talc powder, where the composition is in essence free from organic nucleating agents.

Compositions of this type based on PLA are used (US 2006/093791 A1) for the production of films achieving an enthalpy of fusion of 10 J/g. However, blending with these non-biobased materials causes loss not only of some of the biobased character but also of transparency.

The thermal stability achieved hitherto in the prior art for the PLA-based compositions and for the moldings obtainable therefrom, for example carriers, films and adhesive tapes, is moreover inadequate. In particular, it is inadequate for applications of said moldings in the automobile sector and for applications with adhesives, in particular pressure-sensitive adhesives. Migration of the plasticizers present in the moldings is moreover a continuing problem, and the flexibility of the achievable moldings in the form of sheet products, in particular films, remains unsatisfactory unless restrictions are accepted in the respective other properties such as transparency.

It is therefore an object of the present invention to provide a biobased film which has very good optical and mechanical properties. An essential object of the present invention is to provide a film with improved properties such as degree of crystallization, thermal stability, softness and transparency. Another object of the invention is to provide a film which has very good optical and mechanical properties and in which there is no migration of the plasticizer present, in particular no diffusion thereof out of the material. Another object of the invention is to provide a formulation from which the film described can be produced without any restriction of mechanical and optical properties, in particular degree of crystallization, thermal stability, softness and transparency. Another object of the invention is to provide a process for the production of the formulations, and also of the film.

Addition of at least one plasticizer and of at least one nucleating agent during specific processing of the components eliminate brittleness of the resultant material, in particular of the film, and also improve thermal stability, while retaining the required transparency.

The use of plasticizers and nucleating agents provides a synergistic effect, which on the one hand eliminates stiffness and brittleness from the film and on the other hand, by virtue of specific conduct of a process, can improve the thermal stability of the film. The problematic crackle which is known to be a characteristic of, for example, BO PLA films is avoided.

The use of plasticizers in the composition of the invention based on polylactic acid lowers the glass transition temperature (T_{G}), the ultimate effect of this being to eliminate the brittleness and stiffness of the formulation and film of the invention. The film exhibits relatively high tensile strain at break and relatively low resistance to force. By combining use of nucleating agents and of plasticizers, the invention solves the problem of migration to the surface of plasticizer molecules, which often have low molecular weight and by way of example considerably impair anchoring to an adhesive. Crystallization temperature is thus raised to higher temperatures, with resultant higher crystallinity and higher thermal stability of the formulation of the invention, while migration of plasticizers is prevented.

This combination of the invention, involving suitable proportions of plasticizer and of nucleating agent, and treatment with heat, in particular hot-rolling and/or orientation of the film of the invention, gives rise to a particular synergistic effect. The degree of crystallization observed can be higher than with each additive alone. The degree of crystallization can moreover achieve a value higher than the sum of the individual values. In addition, migration is prevented, and transparency is retained.

The invention firstly provides a biobased film comprising a composition based on polylactic acid comprising the following components
(a) at least one biobased (co)polymer, in particular (co)polyester, based on at least one lactic acid derivative, in particular on a monomer and/or dimer of lactic acid,
(b) at least one plasticizer comprising at least one compound comprising an ester group, with the exception of dimeric and polymeric esters of lactic acid, and
(c) at least one nucleating agent, in particular with an average particle diameter of less than or equal to 2 μm, and
(d) optionally additives.

The invention further provides that the proportion of the respective components in the film of the invention, based on the entire content of the composition (giving 100% by weight), is
(a) from 75% by weight to 98.9% by weight or from 80% by weight to 97% by weight, preferably from 85% by weight to 95% by weight, particularly preferably from 87% by weight to 90% by weight, of the at least one biobased (co)polymer, in particular (co)polyester, based on at least one lactic acid derivative, in particular on a monomer and/or dimer of lactic acid,
(b) from 1% by weight to 20% by weight or from 5% by weight to 15% by weight, preferably from 11% by weight to 13% by weight, particularly preferably 12% by weight, of the at least one plasticizer and
(c) from 0.1% by weight to 5% by weight, preferably from 0.5% by weight to 3% by weight, particularly preferably from 0.5% by weight to 1.5% by weight, of the at least one nucleating agent, in particular with an average particle diameter of from 0.5 μm to 5 μm, preferably less than or equal to 2 μm, or from 0.5 μm to 3 μm or from 0.7 μm to 2.5 μm, particularly preferably from 1.0 μm to 2 μm, and
(d) from 0% by weight to 20% by weight, preferably from 0% by weight to 15% by weight, particularly preferably from 0.5% by weight to 10% by weight, of additives.

In particular, the T_{G} of the film of the invention is 120° C. or lower, preferably 110° C. or lower.

The softness of the film of the invention, measured as tensile strain at break (in accordance with ISO 527), is from 3% to 300%. Softness is the deformability of the film. The deformability of a material can be described by reference to its strength, plasticity and elasticity. A film with 3% and, respectively, 300% tensile strain at break exhibits 3% and, respectively 300% increase of length, based on its initial length, this increase of length being retained after breakage of the sample. The tensile strain at break of the film of the invention is preferably from 30% to 300%, or from 50% to 280%, preferably from 100% to 250%.

The data relating to the tensile strain at break of the film of the invention can refer to oriented films. A tensile strain at break of 130% to 300%, or from 50% to 280%, preferably from 100% to 250%, can therefore refer either to oriented films or to unoriented films. The invention therefore further provides a film which has been oriented, in particular longitudinally, by a factor A of from 1 to 7, particularly from 2 to 6, preferably from 5 to 6, at a temperature above a T_{G}, particularly from 90° C. to 120° C., more preferably from 90° C. to 110° C.

A stretching ratio of 1:6 means that a section of the film of length by way of example 1 m produces a section of length 6 m of the stretched film. The stretching ratio is also often described as quotient calculated from line speed prior to orientation and line speed after orientation. The numerical data used below are based on the stretching process. The stretching process reduces only the thickness of the film, with no substantial decrease of the width of the primary film.

The thermal stability of the film, measured as shrinkage (in accordance with DIN 53377), is in particular from 0% to 5%, preferably from 0% to 3%, particularly preferably from 1% to 4%.

The degree of crystallization of the film, measured as enthalpy of fusion (in accordance with DIN EN ISO 11357-3), is from 30 J/g to 50 J/g, preferably from 35 J/g to 50 J/g, particularly preferably from 40 J/g to 50 J/g.

In particular, no migration of the compounds present in the film of the invention takes place, in particular no migration of the plasticizers comprising esters of di- and/or tricarboxylic acids having at least one alkyl moiety at the at least one ester group selected from C₁ to C₂₀-alkyl moieties comprising methyl, ethyl, propyl, butyl, hexyl, nonyl, dodecyl and octadecyl moieties, preferably comprising esters of citric acid and adipic acid, particularly preferably alkyl citrates such as tributyl citrate, triethyl citrate and tributyl acetyl citrate and/or adipates such as diethylhexyl adipate (dioctyl adipate).

It is particularly preferable that a film oriented by factor A=1 comprising the formulation A, preferably produced from formulation B, has a high tensile strain at break greater than or equal to 250%. This type of film also preferably has high thermal stability, measured as shrinkage less than or equal to 5% at 120° C. In particular, high strength is achieved with orientation by factor A of from 5 to 6.

In another aspect of the invention, the film of the invention has high transparency of from 80% to 100%, preferably from 85% to 98%, with preference from 90% to 97%, measured by means of transmittance at a wavelength of from 400 nm to 800 nm, preferably from 600 nm to 800 nm. Additionally, no migration of the compounds present in these films, in particular of the plasticizers, takes place.

Said high transparency is achieved because plasticizers used are substantially esters of a di- and/or tricarboxylic acid, as explained in more detail below.

The layer thickness of the film of the invention can be from 5 μm to 500 μm, preferably from 5 μm to 50 μm, or from 10 μm to 40 μm, particularly preferably from 15 μm to 30 μm. The arrangement can have a plurality of films of different layer thickness mutually superposed in the form of a plurality of layers: it can be advantageous for the stability and/or flexibility of the film of the invention to combine film layers of different layer thickness (for example 5 μm, 10 μm, 15 μm, 20 μm, 30 μm and 40 μm) using at least two layers to give a film. In particular, films of different layer thickness with different degrees of orientation can be combined: a film can therefore have a layer thickness of from 10 μm, 15 μm, 20 μm or 25 μm to 30 μm, 35 μm or 40 μm and a degree of orientation with a factor A of from 1, 2, 3, 4, 5 or 6 to 7.

The invention further provides a formulation A, and in particular a formulation B, comprising polylactic acid comprising the following components
(a) at least one biobased (co)polymer, in particular (co)polyester, based on at least one lactic acid derivative, in particular on a monomer and/or dimer of lactic acid,
(b) at least one plasticizer comprising at least one compound comprising an ester group, with the exception of dimeric and polymeric esters of lactic acid, and
(c) at least one nucleating agent, in particular with an average particle diameter of less than or equal to 2 μm, and
(d) optionally additives.

It is preferable that the proportion present of each component of the formulation A of the invention, and in particular of the formulation B of the invention, based on the entire content of the composition (giving 100% by weight), is
(a) from 75% by weight to 98.9% by weight or from 80% by weight to 97% by weight, preferably from 85% by weight to 95% by weight, particularly preferably from 87% by weight to 90% by weight, of the at least one biobased (co)polymer, in particular (co)polyester, based on at least one lactic acid derivative, in particular on a monomer and/or dimer of lactic acid,
(b) from 1% by weight to 20% by weight or from 5% by weight to 15% by weight, preferably from 11% by weight to 13% by weight, particularly preferably 12% by weight, of the at least one plasticizer,
(c) from 0.1% by weight to 5% by weight, preferably from 0.5% by weight to 3% by weight, particularly preferably from 0.5% by weight to 1.5% by weight, of the at least one nucleating agent, in particular with an average particle diameter of from 0.5 μm to 5 μm, preferably less than or equal to 2 μm, or from 0.5 μm to 3 μm or from 0.7 μm to 2.5 μm, particularly preferably from 1.0 μm to 2 μm, and
(d) from 0% by weight to 15% by weight of additives.

In a particular embodiment of the formulation A, and in particular of the formulation B, the proportion present of each component, based on the entire content of the composition (giving 100% by weight), is
(a) from 86% by weight to 88.5% by weight of the at least one biobased (co)polymer, in particular (co)polyester, based on at least one lactic acid derivative, in particular on a monomer and/or dimer of lactic acid,
(b) from 11% by weight to 13% by weight of the at least one plasticizer,
(c) from 0.5% by weight to 1.5% by weight of the at least one nucleating agent, and
(d) from 0% by weight to 15% by weight, preferably less than or equal to 10% by weight, of additives.

A particular synergistic effect of the components present in the formulation A, and in particular in formation B, and therefore in the film of the invention, has been determined when the proportion present of the at least one polyester (a) of the invention based on lactic acid is less than or equal to 87% by weight, the proportion present of the plasticizer is 12% by weight, and that of the nucleating agent is 1% by weight, based on the entire content of the composition. Additives can be added if necessary, and in that case the proportion of the at least one polyester (a) is reduced correspondingly. In the case of a combination with one or more further polyesters the proportion of (a) the at least one lactic-acid-based polymer is adjusted correspondingly.

In another aspect of the invention, the formulation A, and also the formulation B, and in particular the film of the invention obtainable from the formulation A, comprises at least (a) one biobased (co)polymer, in particular polyester, comprising at least one lactic acid derivative in the form of at least one monomer and/or dimer selected from L(S)-lactic acid, D(R)-lactic acid (S,S)-lactide, (R,R)-lactide and (meso)lactide and mixtures of at least two of the compounds mentioned. In particular, preference is given to polymers such as poly(L)-lactide and copolymers such as poly(D,L)-lactide and poly(L)-lactide-co-(D,L)-lactide.

Lactic acid is a hydroxycarboxylic acid having a carboxy group and a hydroxy group. It can take the form of different isomers: L(S)-lactic acid and D(R)-lactic acid, which are monomers for the purposes of the invention. D-lactic acid is described as levorotatory lactic acid and L-lactic acid is described as dextrorotatory lactic acid. R is synonymous with D and S is synonymous with L. Racemates are mixtures of the two isomers in a ratio of 1:1.

Lactide is a cyclic diester of lactic acid, and for the purposes of the invention is a dimer of lactic acid. By analogy with the monomers, dimers can likewise take the form of different isomers: (S,S)-lactide, (R,R)-lactide and (meso)-lactide. The lactide of L-lactic acid (synonymous with (S)-lactic acid) has (S,S) configuration, i.e. is (S,S)-lactide, and the lactide of D-lactic acid (synonymous with (R)-lactic acid) has (R,R) configuration, therefore being (R,R)-lactide. (meso)-Lactide is composed of L- and D-lactic acid and is therefore an (R,S)-lactide and has two asymmetric centers with opposite configuration R and S.

For the purposes of the invention, polymers used both in the film and in the formulations A and B are preferably polyesters and comprise homopolymers of one of the abovementioned lactic acid derivatives and copolymers of at least two of the lactic acid derivatives mentioned or a mixture of the homopolymers and copolymers. Examples of lactic-acid-based homopolymers are polyesters of L-lactic acid such as poly(L)-lactide and of the racemate D,L-lactic acid such as poly(D,L)-lactide. Examples of copolymers are polyesters of L-lactide with D-lactide such as poly(L)-lactide-co-(D)-lactide or L-lactide with D,L-lactide such as poly(L)-lactide-co(D,L)-lactide. Compounds in particular preferred as lactic-acid-based polymers are those such as poly(L)-lactide and copolymers such as poly(D,L)-lactide and poly(L)-lactide-co-(D,L)-lactide. The ratios of the at least two monomers to one another in the copolymers can vary from 30:1 to 1:30.

Use of lactic acid derivatives in the formulations A and B achieves biobased films which are preferably biodegradable in accordance with DIN EN 13432. For the purposes of the present invention, biobased means that the compound to which this term is applied is based on renewable raw materials and has been produced exclusively therefrom.

Biobased raw materials are consequently compounds such as monomers, dimers, polymers, plasticizers and nucleating agents which are not petroleum-based. Monomers derived from cracked petroleum which may then have been fermented are therefore not considered to be biobased.

In a particular embodiment, the copolymer of lactic acid can comprise as a second monomer (b) a compound selected from the group comprising (i) aliphatic and aromatic mono/dicarboxylic acids such as valeric acid (butylcarboxylic acid), succinic acid (succinate), malic acid, adipic acid, maleic acid, alpha- and beta-hydroxy acids, terephthalic acid, lactic acid, glycolic acid, butyric acid (beta), hydroxyvaleric acid, mevalonic acid and/or (ii) alpha-,omega-diols containing alkyl groups, comprising 1,2-, 1,3- or 1,4-alkyldiols comprising ethyl, propyl, or butyl, preferably 1,4-butanediol, 1,3-propanediol, and also mixtures of at least two of the compounds mentioned.

Possible copolymers of lactic acid comprise by way of example poly(L)-lactide-co-glycolide and poly(D,L)-lactide-co-glycolide. The chronology of degradation of the polyester in the film can be controlled by copolymerizing the lactic acid with a glycolic acid lactide, because glycolic acid retards degradation of the polyester. The desired degradation, or the lifetime of the film, and also of the formulation B described below for the production of the film of the invention, can be adjusted appropriately via the mixing ratio of the two acids or their lactones.

Particular preference is given to polyesters that comprise biobased monomers and/or are biodegradable in accordance with DIN EN 13432. Mixtures of a plurality of such polyesters are, of course, also suitable.

It is preferable that the films of the invention, and in particular the corresponding formulations A and B, comprise at least one biobased polyester in the form of polylactic acid (PLA) homopolymer. Examples are Compostable® from Cereplast, Ecopond PLA-873 from Kingfa, Bio-Flex® A4100 CL from FKuR, FT1 from Minima, all of the Ingeo products from NatureWorks, Kareline® from Plasthill, all of the Natureplast products and PLA from RTP., Bio-Flex from FKuR Kunststoff GmbH, Biocycle from Klöckner Pentaplast GmbH & Co. KG., Biofront from Teijin Chemicals Ltd., Biopearls from Biopearls, Biophan from Treofan Germany GmbH & Co. KG., Ceramis from Alcan Packaging Kreuzlingen GmbH, Earthfirst from Sidaplax V.O.F., Ecodear from Toray Industries, Inc., Ecovio from BASF SE, Evlon from Bi-Ax International Inc., Fozeas from Mitsubishi Chemical Corporation, Ingeo from NatureWorks LLC, Lacea from Mitsui Chemicals, Puralct from Purac, and Terramac from Unitika Ltd.

It is possible, if necessary, to use one or more further polymers alongside a polyester based on polylactic acid. Possible polymers comprise polyethylene terephthalate (PET), polytrimethylene terephthalate (PTT), polybutylene terephthalate (PBT), polyimide (PA), polyurethane (PU), polybutyl succinate (PBS), polyhydroxyalcanoate, polylactic acid (PLA) and its copolymers, scPLA, PPLA, polycaprolactone and starch.

The formulation A of the invention and the film of the invention comprise as second component (b) at least one plasticizer comprising at least one compound comprising an ester group, with the exception of dimeric and polymeric esters of lactic acid.

A further aspect of the invention is consequently a formulation A, and in particular a formulation B, where (b) the at least one plasticizer is an ester of a di- or tricarboxylic acid, comprising (i) aliphatic saturated or unsaturated and (ii) aromatic saturated or unsaturated di- and tricarboxylic esters. Preference is given to use of biobased plasticizers based on carboxylic esters. Use of the plasticizer of the invention, in particular the esters of carboxylic acids, improves integration of the plasticizer into the polyester, preferably into the polylactic acid. The molecular weight M_{w} of the plasticizer is particularly preferably from 100 to 10 000, from 100 to 1000, or from 200 to 800, preferably from 250 to 500. The plasticizer is preferably a short-chain plasticizer. These plasticizers specifically can provide the synergistic effect described between plasticizer and nucleating agent, achieving improved thermal stability and good transparency and simultaneously preventing migration of the plasticizers.

Di- and tricarboxylic acids for the purposes of the invention comprise acids having two or three COOH groups and a hydrocarbon moiety having from 2 to 40 C atoms, preferably from 2 to 20 C atoms, particularly preferably from 2 to 12 C atoms. These can be branched and saturated, unbranched and saturated, or else branched and unsaturated or unbranched and unsaturated. Examples of unbranched saturated dicarboxylic acids comprise oxalic acid, malonic acid, succinic acid, glutaric acid, adipic acid, pimelic acid, suberic acid and azelaic acid. Examples of tricarboxylic acids are the aliphatic citric acid and trimesic acid and the aromatic trimellitic acid and hemimellitic acid.

The esters of the respective acids are formed with mono-, di- or trihydric aliphatic saturated alcohols having from 2 to 40 C atoms, preferably having from 2 to 20 C atoms, particularly preferably having from 2 to 6 C atoms.

The esters of the di- and/or tricarboxylic acids preferably comprise at least one alkyl moiety at the at least one ester group selected from C₁ to C₂₀-alkyl moieties comprising methyl, ethyl, propyl, butyl, hexyl, nonyl, dodecyl and octadecyl moieties.

It is preferable to use esters of citric acid and adipic acid, preferably alkyl citrates such as tributyl citrate, triethyl citrate and tributyl acetyl citrate and/or adipates such as diethylhexyl adipate (dioctyl adipate). These plasticizers have no adverse effect on the transparency of the film. In particular, the plasticizers do not diffuse out of the film of the invention and/or formulation B.

It is preferably to use plasticizers which have no adverse effect on the biodegradability of the formulation A and of the film of the invention obtainable therefrom. It is preferable that the at least one plasticizer alone, or in combination with (a) the at least one polymer, (c) at least one nucleating agent and/or the optional additives of the formulation A, is biodegradable in accordance with DIN EN 13432.

The formulation A of the invention comprises as third component at least (c) a nucleating agent which is simultaneously a nucleation accelerator, comprising in particular natural, biobased and/or synthetic waxes, mineral fillers and biobased fillers.

Nucleating agents that can be selected are talc powder, chalk, carbon black, graphite, calcium stearate or zinc stearate, poly-D-lactic acid, N,N′-ethylenebis-12-hydroxystearamide, polyglycolic acid, sodium phenylphosphinate, aluminum oxide, silicon dioxide, and also preferably talc powder.

Waxes comprise compounds comprising an ester group, for example fatty acid esters and fatty alcohols with long-chain aliphatic alcohols and with long-chain aliphatic carboxylic acids, free or unbonded ketones, free or unbonded alcohols, free or unbonded fatty acids and saturated and unsaturated hydrocarbon compounds, and also compounds comprising an amide group.

Natural waxes comprise waxes which can be obtained from a natural source, comprising plant-derived and animal-derived waxes. Examples of animal-derived waxes are spermaceti and bees wax, and examples of plant-derived waxes are sugar cane wax and carnauba wax from the wax palm. In particular stearin, which is a mixture of stearic acid and palmitic acid, is obtained mainly from plant-derived palm oil or from animal fats. Stearin and derivatives thereof are preferred, preferably stearin derivatives containing an amide group, for example ethylenebisstearamide, because stearin is biodegradable. Jojoba oil is an example of a liquid wax. Among the natural waxes are also those known as mineral waxes, an example being ozocerite, which consists essentially of hydrocarbons.

Biobased waxes are waxes produced synthetically by processes which are known to the person skilled in the art but which for the purposes of the invention use biobased starting materials. By way of example, polyethylene and copolymers thereof can be synthesized entirely from biobased monomers. The expression synthetic waxes also includes waxes which come from a natural source but which are chemically modified for use. By way of example, a soya wax can be produced by hydrogenation of soya.

Particular mineral fillers that may be mentioned are silicon dioxides (spherical, acicular or or irregular shape, an example being fumed silicas), calcium carbonates, zinc oxides, titanium dioxides, aluminum oxides, aluminum hydroxides and aluminum oxide hydroxides, magnesium hydroxides, magnesium oxides, zinc oxides and calcium oxides, and carbonates/sulfates comprising chalk, dolomite, baryte; oxides/hydroxides such as powdered quartz and silicates comprising clay, loam, talc, mica, kaolin, Neuburg siliceous earth.

Biobased or organic fillers that can be used are in particular plant-derived and also animal-derived materials, optionally in combination with one another. Organic fillers are very preferably in fine-particle form, in particular in the form of fibers, coarse granular material, dust or flour. Preferred plant-derived organic fillers selected are renewable raw materials (renewable organic materials), in particular wood, calk, hemp, flax, grasses, reed, straw, hay, cereal, maize, nuts or constituents of the abovementioned materials, for example shells (for example shells of nuts), kernels, hair or the like. Materials in particular used, with no intention that the list results in any unnecessary restriction of the teaching of the invention, are wood flours, cork flours, cereal flours, maize flours and/or potato flours. Particular animal-derived organic fillers used advantageously and in particular in fine-particle (ground) form are bones, chitin (for example crustacean shells, insect carapaces), hair, bristles and horn. Materials preferably used as filler are cellulose powders such as wood flour, starch—plastified with plasticizers such as glycerol or sorbitol, or unplastified, starch derivatives, cereals and/or cellulose derivatives.

Preferred nucleating agents are ethylenebisstearamide from the group of the waxes and talc powder from the group of the mineral fillers.

The formulation A of the invention preferably comprises as (c) the at least one nucleating agent comprising wax and/or mineral fillers with an average particle diameter of from 0.5 μm to 5 μm, preferably less than or equal to 2 μm, preferably from 0.5 μm to 3 μm, or from 0.7 μm to 2.5 μm, particularly preferably from 1.0 μm to 2 μm.

The nucleating agent also affects the transparency of the film obtainable from the formulation A and/or B. If high transparency is desired, the average particle diameter should be from 0.05 μm to 2 μm, preferably from 0.05 μm to 0.2 μm.

Where necessary, the film of the invention can comprise additives, and/or (d) additives can be added to the formulation A and/or formulation B. Additives comprise antiblocking agents, dye, optical brighteners, antistatic agents, antifogging agents, lubricants, UV absorbers, fillers, additives relevant to peeling and/or sealing, antioxidants and/or processing aids. The respective additives can be incorporated into the formulation A, or can be incorporated thereafter into formulation B. The at least one additive can moreover be present in one or more film layers or films in the film structure of the invention.

Possible additives are listed by way of example below, and the selection and function of the respective additives is known to the person skilled in the art, as also is the effect on the properties of the film.
(1) Acid scavengers for increasing hydrolysis resistance. This procedure is preferred especially for polyesters with high initial acid number. Preferred acid scavengers are in particular compounds selected from the group consisting of bisoxazoline, polyoxazoline, carbodiimide, polymeric carbodiimide, dicaprolactam, polymeric caprolactam, bisoxazine and polyoxazine,
(2) lubricants, for example preferably long-chain fatty acids (for example stearic acid or behenic acid), salts thereof (for example Ca stearate or Zn stearate) or montan waxes (mixtures of straight-chain, saturated carboxylic acids having chain lengths of from 28 to 32 C atoms) or salts thereof with alkali metals or with alkaline earth metals, preferably Ca montanate and/or sodium montanate, and also low-molecular-weight polyethylene waxes and, respectively, polypropylene waxes,
(3) fillers such as glass fibers,
(4) UV stabilizers such as various substituted resorcinols, salicylates, benzotriazoles and benzophenones, and preferably organic phosphatines such as tetrakis-(2,4-di-tert-butylphenyl) biphenylenediphosphonite and/or
(5) dyes and inorganic pigments such as ultramarine blue, iron oxide, zinc sulfide and/or titanium dioxide, and also organic pigments such as phthalocyanines, quinacridones, perylenes, and also dyes such as anthraquinones.

Preferred embodiments of the formulation A of the invention, and in particular of the formulation B of the invention, for the production of the film of the invention comprise: Formulation A-1 (entire content of the composition to give 100% by weight)
(a) PLA comprising poly(L)-lactide, poly(D,L)-lactide and/or poly(L)-lactide-co-(D)-lactide preferably poly(L-)lactide and/or poly(L)-lactide-co-(D)-lactide, in a proportion of from 75% by weight or optionally 60% by weight to 98.9% by weight or from 80% by weight to 97% by weight, preferably from 85% by weight to 95% by weight, particularly preferably from 87% by weight to 90% by weight,
(b) as plasticizer, citric ester, preferably tributyl citrate, triethyl citrate and/or tributyl acetyl citrate in a proportion of from 1% by weight to 20% by weight or from 5% by weight to 15% by weight, preferably from 11% by weight to 13% by weight, particularly preferably 12% by weight,
(c) as nucleating agent, in a first alternative ethylene-bis-stearamide, or in a second alternative talc powder, in each case in a proportion of from 0.1% by weight to 5% by weight, preferably from 0.5% by weight to 3% by weight, particularly preferably from 0.5% by weight to 1.5% by weight,

Formulation A-2 (entire content of the composition to give 100% by weight)
(a) PLA comprising poly(L)-lactide, poly(D,L)-lactide and/or poly(L)-lactide-co-(D)-lactide, preferably poly(L-)lactide and/or poly(L)-lactide-co-(D)-lactide, in a proportion of from 75% by weight or optionally 60% by weight to 98.9% by weight or from 80% by weight to 97% by weight, preferably from 85% by weight to 95% by weight, particularly preferably from 87% by weight to 90% by weight,
(b) as plasticizer, citric ester, preferably tributyl citrate, triethyl citrate and/or tributyl acetyl citrate in a proportion of from 1% by weight to 20% by weight or from 5% by weight to 15% by weight, preferably from 11% by weight to 13% by weight, particularly preferably 12% by weight,
(c) as nucleating agent, in a first alternative ethylene-bis-stearamide, or in a second alternative talc powder, of size from 0.5 μm to 5 μm, preferably less than or equal to 2 μm, preferably from 0.5 μm to 3 μm or from 0.7 μm to 2.5 μm, particularly preferably from 1.0 μm to 2 μm, and in a proportion of from 0.1% by weight to 5% by weight, preferably from 0.5% by weight to 3% by weight, particularly preferably from 0.5% by weight to 1.5% by weight,

Formulation A-3 (entire content of the composition to give 100% by weight)
(a) PLA comprising poly(L)-lactide, poly(D,L)-lactide and/or poly(L)-lactide-co-(D)-lactide, preferably poly(L-)lactide and/or poly(L)-lactide-co-(D)-lactide, in a proportion of from 77% by weight or optionally 65% by weight to 98.5% by weight or from 80% by weight to 97% by weight, preferably from 85% by weight to 95% by weight, particularly preferably from 87% by weight to 90% by weight,
(b) as plasticizer, citric ester, preferably tributyl citrate, triethyl citrate and/or tributyl acetyl citrate in a proportion of from 1% by weight to 20% by weight or from 5% by weight to 15% by weight, preferably from 11% by weight to 13% by weight, particularly preferably 12% by weight,
(c) as nucleating agent, in a first alternative ethylene-bis-stearamide, or in a second alternative talc powder of size less than or equal to 2 μm, preferably from 0.5 μm to 3 μm or from 0.7 μm to 2.5 μm, and in a proportion of from 0.5% by weight to 3% by weight, particularly preferably from 0.5% by weight to 1.5% by weight,

Formulation A-4 (entire content of the composition to give 100% by weight)
(a) PLA comprising poly(L)-lactide, poly(D,L)-lactide and/or poly(L)-lactide-co-(D)-lactide, preferably poly(L-)lactide and/or poly(L)-lactide-co-(D)-lactide, in a proportion of from 80% by weight or optionally 65% by weight to 94.9% by weight or from 80% by weight to 97% by weight, preferably from 85% by weight to 95% by weight, particularly preferably from 87% by weight to 90% by weight,
(b) as plasticizer, citric ester, preferably tributyl citrate, triethyl citrate and/or tributyl acetyl citrate in a proportion of from 5% by weight to 15% by weight, preferably from 11% by weight to 13% by weight, particularly preferably 12% by weight,
(c) as nucleating agent, in a first alternative ethylene-bis-stearamide, or in a second alternative talc powder in each case with a particle diameter of from 0.5 μm to 5 μm, preferably less than or equal to 2 μm, preferably from 0.5 μm to 3 μm or from 0.7 μm to 2.5 μm, particularly preferably from 1.0 μm to 2 μm, and in a proportion of from 0.1% by weight to 5% by weight, preferably from 0.5% by weight to 3% by weight, particularly preferably from 0.5% by weight to 1.5% by weight,

Formulation A-5 (entire content of the composition to give 100% by weight)
(a) PLA comprising poly(L)-lactide, poly(D,L)-lactide and/or poly(L)-lactide-co-(D)-lactide, preferably poly(L-)lactide and/or poly(L)-lactide-co-(D)-lactide, in a proportion of from 82% by weight or optionally 67% by weight to 88.9% by weight or from 80% by weight to 97% by weight, preferably from 85% by weight to 95% by weight, particularly preferably from 87% by weight to 90% by weight,
(b) as plasticizer, citric ester, preferably tributyl citrate, triethyl citrate and/or tributyl acetyl citrate in a proportion of from 11% by weight to 13% by weight, particularly preferably 12% by weight,
(c) as nucleating agent, in a first alternative ethylene-bis-stearamide, or in a second alternative talc powder in each case with a particle diameter of from 0.5 μm to 5 μm, preferably less than or equal to 2 μm, preferably from 0.5 μm to 3 μm or from 0.7 μm to 2.5 μm, particularly preferably from 1.0 μm to 2 μm, and in a proportion of from 0.1% by weight to 5% by weight, preferably from 0.5% by weight to 3% by weight, particularly preferably from 0.5% by weight to 1.5% by weight,

Formulation A-6 (entire content of the composition to give 100% by weight)
(a) PLA, preferably poly(D,L)-lactide and/or poly(L)-lactide-co-(D)-lactide, in a proportion of from 85.5% by weight, or optionally 70.5% by weight, to 88.5% by weight,
(b) as plasticizer, citric ester, preferably tributyl citrate, triethyl citrate and/or tributyl acetyl citrate in a proportion of from 11% by weight to 13% by weight, particularly preferably 12% by weight,
(c) as nucleating agent, in a first alternative ethylene-bis-stearamide, or in a second alternative talc powder, in each case with a particle diameter of less than or equal to 2 μm and with a proportion of from 0.5% by weight to 1.5% by weight.

The compositions of these formulations A-1 to A-6 comprise no data relating to the optional additives, because these are added only if necessary in desired quantities of from 0% by weight to less than 15% by weight. If additives are added, the proportion of the (a) at least one biobased polymer in respective formulations is correspondingly reduced. The data relating to the formulations A-1 to A-6 apply correspondingly to formulations B-1, B-2, B-3, B-4, B-5 and B-6.

The function of a nucleating agent is to reduce free surface energy in order to favor nucleation and thus initiation of crystallization at higher temperatures after/during cooling. Use of the nucleating agents of the invention, preferably ethylene-bis-stearamide or talc powder, therefore leads to an increase of nucleation by a factor of from 5 to 10 and to crystallization increased by a factor of from 2 to 6. The function of a plasticizer is to increase the mobility of the polymer chains and thus to increase the crystallization by reducing the energy required for folding of the polymer chains during crystallization. The inventive combination of the nucleating agent and plasticizer leads not merely to summation of the effects; instead, the effects act synergistically.

Talc powder alone does not lead to any significant increase of crystallization of PLA. However, if talc powder or ethylene-bis-stearamide is used in combination with a plasticizer, preferably tributyl citrate, triethyl citrate and/or tributyl acetyl citrate, crystallization of PLA is markedly improved.

At the same time, by virtue of this synergistic effect the plasticizer used becomes firmly anchored in the formulation B and/or in the film of the invention, in particular via a large number of hydrogen bonds between the ester groups of the plasticizers and the ester groups of the at least one (a) polymer, and also preferably (c) the at least one amide group and/or hydroxy group of the at least one nucleating agent.

The invention likewise provides a process for the production of the film of the invention, and also film obtained by the process, where
in the first step a formulation A is provided via mixing, in particular in order to obtain homogeneous distribution of the plasticizer in the formulation, of
(a) at least one biobased, preferably also biodegradable, (co)polymer, in particular (co)polyester, based on at least one lactic acid derivative, in particular on a monomer and/or dimer of lactic acid,
(b) at least one plasticizer comprising at least one compound comprising an ester group, with the exception of dimeric and polymeric esters of lactic acid, and
(c) at least one nucleating agent, and
(d) optionally additives,
where the sequence of mixing is not significant. The (a) polymer, or another abovementioned compound, can be used as initial charge, and the other components can be mixed therewith,
in a further step, a formulation B is produced by introduction of heat, preferably up to a processing temperature of from 170° C. to 190° C., particularly preferably 180° C., in particular melting in an extruder, preferably twin-screw extruder, preferably with homogeneously distributed plasticizer in the formulation A, optionally adding at least one additive and
in a subsequent step, the film is molded, in particular by extrusion, preferably by means of a single-screw extruder.

The invention further provides that in the process of the invention
in the further step the formulation B is obtained via melting of the formulation A, in particular in a twin-screw extruder, and optionally at least one additive is added,
in a next step, the resultant formulation B is optionally cooled, in particular in a water bath, and
in a subsequent step the film is molded.

In the process of the invention in a preferred embodiment
in a further step the molten formulation B, and optionally cooled formulation B, is/are granulated, and optionally at least one additive is added before or after the cooling, and
in a subsequent step the film made of the granulate of the formulation B is molded, preferably via (a) introduction of heat, preferably up to a processing temperature of from 170° C. to 190° C., particularly preferably 180° C., in particular melting in an extruder and optionally addition of at least one additive, in particular a single-screw extruder, (b) extrusion of the heated formulation B, in particular of the melt by means of a flat-film die, (c) molding of the film and optionally (d) cooling, in particular on a chill roll, preferably at a temperature of from 20° C. to 60° C., preferably 40° C.

The invention further provides a film produced by the process described. It is preferable that this film has additionally been oriented, as explained below.

It is preferable in the process of the invention that in a following step the film of the invention obtained from the formulation A and/or B is longitudinally oriented at a temperature above the T_{G}, particularly from 90° C. to 120° C., more preferably from 90° C. to 110° C., in particular in a stretching unit, by a factor A of from 1 to 7, particularly from 1 to 6, preferably from 5 to 6.

The invention further provides a formulation B obtainable by the process of the invention, where the thermal stability of the formulation B, measured as shrinkage (in accordance with DIN 53377) is from 0% to 5%. The shrinkage of the formulation B is preferably from 0% to 3%, particularly preferably from 1% to 3%. In particular, the thermal stability, measured as shrinkage (in accordance with DIN 53377), of a film comprising formulation B and produced from the formulation B is the same: from 0% to 5%, preferably from 0% to 3%, particularly preferably from 1% to 3%.

The degree of crystallization of the formulation B of the invention, measured as enthalpy of fusion (in accordance with DIN EN ISO 11357-3), is from 30 J/g to 50 J/g, preferably from 35 J/g to 50 J/g, particularly preferably from 40 J/g to 50 J/g. In particular, the degree of crystallization, measured as enthalpy of fusion (in accordance with DIN EN ISO 11357-3), of a film comprising formulation B and produced from the formulation B is the same: from 30 J/g to 50 J/g, preferably from 35 J/g to 50 J/g, particularly preferably from 40 J/g to 50 J/g.

In another embodiment of the formulation B of the invention, no migration of the compounds present, in particular of the plasticizers, takes place. In particular, in a film comprising formulation B and produced from the formulation B no migration of the compounds present takes place, in particular of the plasticizers comprising esters of di- and/or tricarboxylic acids having at least one alkyl moiety at the at least one ester group selected from C₁ to C₂₀-alkyl moieties comprising methyl, ethyl, propyl, butyl, hexyl, nonyl, dodecyl and octadecyl moieties, preferably comprising esters of citric acid and adipic acid, particularly preferably alkyl citrates such as tributyl citrate, triethyl citrate and tributyl acetyl citrate and/or adipates such as diethylhexyl adipate (dioctyl adipate).

The invention further provides the use of the formulation B comprising in the form of flowable solid material comprising briquettes, granulates, extrudates, pellets, grains and powders, or in the form of banderoles, strands, products supplied by the yard, slabs, cylinders and/or sheets for the production of carriers in the form of
(a) sheetlike elements comprising sheetlike elements produced by spinning, weaving and/or melting, for example nonwovens, films, wovens, scrims, nets, textiles and textile tapes and/or
(b) fiber structures comprising yarns, knits, braids, filaments and fibers produced by spinning, weaving and/or melting and
   sheetlike elements comprising fiber structures.

The invention further provides a pressure-sensitive-adhesive sheet product comprising the film of the invention and at least one adhesive in the form of at least one layer, preferably a biobased, with preference also biodegradable, pressure-sensitive adhesive. Suitable adhesives are described in WO 2013/060624 A1, WO 2012/126773 A1, EP 2 647 682 A1 or WO 2014/154479 A1.

Biobased Means Produced from Renewable Raw Materials.

Biodegradable polymers is an expression used for natural and synthetic polymers which have plastics-like properties (notched impact resistance, thermoplastifier ability), but in contrast to conventional plastics are degraded by a wide variety of microorganisms in a biologically active environment (compost, sludge, soil, waste water); this does not necessarily take place under conventional household conditions (garden composting). A definition of biodegradability is found in the European standards DIN EN 13432 (biodegradation of packaging) and DIN EN 14995 (compostability of plastics).

Any of the known adhesive systems can be used to produce an adhesive tape from the film. Adhesives that can be used are not only those based on natural or synthetic rubber but also in particular silicone adhesives, and also polyacrylate adhesives, preferably a pressure-sensitive hot melt acrylate adhesive. Solvent-free hot melt acrylate compositions, as described in more detail in DE 198 07 752 A1 and DE 100 11 788 A1, are preferable because they have particular suitability as adhesive for wrapping tapes of automobile cable harnesses in respect of freedom from fogging, and also excellent compatibility with PVC-containing, and also PVC-free, core insulation materials. Application weight is preferably in the range from 15 to 200 g/m², more preferably from 30 to 120 g/m² (corresponding approximately to a thickness of from 15 to 200 μm, more preferably from 30 to 120 μm).

It is preferable that the adhesive is a pressure-sensitive adhesive, i.e. an adhesive which permits durable bonding to almost all substrates, even when the pressure applied is relatively small, and which can in turn be released from the substrate after use to leave in essence no residue. A pressure-sensitive adhesive has permanent pressure-sensitive-adhesive properties, i.e. has sufficiently low viscosity and high initial tack, and therefore wets the surface of the respective substrate even when the pressure applied is small. The adhesive-bonding capability of the adhesive derives from its adhesive properties, and its subsequent release properties derive from its cohesive properties.

A suitable adhesive is an acrylate-hot melt-based adhesive having a K value of at least 20, in particular more than 30 (measured in each case in 1% by weight solution in toluene at 25° C.), obtainable via concentration of a solution of this type of composition to give a system processable as hot melt.

(FIKENTSCHER) K value is a measure of the average molecular size of highly polymeric materials. The viscosity of polymers is determined by using a capillary viscometer in accordance with DIN EN ISO 1628-1:2009).

The measurement is made by producing one-per-cent (1 g/100 ml) polymer solutions in toluene at 25° C. and using the corresponding DIN Ubbelohde viscometer in accordance with ISO 3105:1994, table B.9 for measurement.

The concentration process can take place in appropriately equipped tanks or extruders; preference is given to a vented extruder in particular when concomitant devolatilization is required.

DE 43 13 008 C2 describes an adhesive of this type. The solvent is completely removed in an intermediate step from the acrylate compositions thus produced.

Other volatile constituents are also removed here. After coating from the melt, these compositions retain only small proportions of volatile constituents. It is thus possible to adopt any of the monomers/formulations claimed in the patent cited above.

The solution of the composition can comprise from 5 to 80% by weight, in particular from 30 to 70% by weight, of solvent.

It is preferable to use commercially available solvents, in particular low-boiling-point hydrocarbons, ketones, alcohols and/or esters.

It is further preferable to use single-screw, twin-screw or multiscrew extruders with one, or in particular two or more, devolatilization units.

The adhesive based on acrylate hot melt can comprise copolymerized benzoin derivatives, for example benzoin acrylate or benzoin methacrylate, or acrylic esters or methacrylic esters. Bezoin derivatives of this type are described in EP 0 578 151 A.

The adhesive based on acrylate hot melt can be UV-crosslinked. However, other types of crosslinking are also possible, an example being electron-beam crosslinking.

In another preferred embodiment, the following are used as self-adhesive compositions: copolymers of (meth)acrylic acid and of esters thereof having from 1 to 25 C atoms, of maleic, fumaric and/or itaconic acid and/or of esters thereof, of substituted (meth)acrylamides, of maleic anhydride and other vinyl compounds, for example of vinyl esters, in particular of vinyl acetate, of vinyl alcohols and/or of vinyl ethers. Residual solvent content should be less than 1% by weight.

An adhesive found to be particularly suitable is a pressure-sensitive acrylate hot melt adhesive marketed by BASF as acResin, in particular acResin A 260 UV. This low-K-value adhesive obtains its application-oriented properties via final crosslinking induced by radiation-chemistry methods.

It is preferable that the adhesive has been applied to the entire surface of the carrier.

The adhesive can have been applied in the longitudinal direction of the adhesive tape in the form of a strip of width smaller than that of the carrier material of the adhesive tape. In an advantageous embodiment, the width of the strip is from 10 to 80% of the width of the carrier material. It is particularly preferable to use strips with a coating of from 20 to 50% of the width of the carrier material.

It is also possible, if required by a particular use, that a plurality of parallel strips of the adhesive have been coated on the carrier material.

The position of the strip on the carrier can be selected freely, preference being given here to an arrangement directly at one of the edges of the carrier.

There can moreover be two adhesive strips provided, and specifically one adhesive strip on the upper side of the carrier material and one adhesive strip on the underside of the carrier material, the two adhesive strips preferably having been arranged at the mutually opposing longitudinal edges. In one variant, the two adhesive strips have been arranged at the same longitudinal edge.

It is preferable that the edge of the adhesive strip(s) is flush with the longitudinal edge(s) of the carrier material.

On the adhesive coating of the carrier, at least one strip of a covering material can have been provided which extend(s) in the longitudinal direction of the adhesive tape and which cover(s) from 20% to 90% of the adhesive coating.

It is preferable that the strip covers, in total, from 50% to 80% of the adhesive coating. The degree of cover is selected as required by the application and by the diameter of the cable harness.

The percentage values stated are based on the width of the strips of the covering material in relation to the width of the carrier.

In a preferred embodiment of the invention, there is precisely one strip of the covering material present on the adhesive coating.

The position of the strip on the adhesive coating can be selected freely, preference being given here to an arrangement directly on one of the longitudinal edges of the carrier. An adhesive strip is thus obtained which extends in the longitudinal direction of the adhesive tape and which concludes at the other longitudinal edge of the carrier.

If the adhesive tape is used for the wrapping of a cable harness in that the adhesive tape is passed in a helical motion around the cable harness, the wrapping of the cable harness can be achieved in a manner such that the adhesive of the adhesive tape is adhesive-bonded only on the adhesive tape itself, while the target materials does not come into contact with any adhesive.

The cable harness thus wrapped has very high flexibility because there is no adhesive fixing the cables. This significantly increases the flexibility of the harness during installation—and this specifically applies in narrow passageways or sharp bends.

If a certain degree of fixing of the adhesive tape on the target material is desired, the wrapping method can be such that one part of the adhesive strip is adhesive-bonded on the adhesive tape itself and that another part is adhesive-bonded on the target material.

In another advantageous embodiment, the strip has been applied centrally on the adhesive coating in a manner that gives two adhesive strips extending along the longitudinal edges of the carrier in the longitudinal direction of the adhesive tape. The two adhesive strips respectively present at the longitudinal edges of the adhesive tape are advantageous for reliable and cost-effective application of the adhesive tape in said helical motion around the cable harness and for inhibiting slip of the resultant protective wrapping, in particular if one strip, which is mostly narrower than the second strip, serves as fixing aid and the second, wider strip serves as seal. The adhesive bonding of the adhesive tape on the cable is thus such that the cable harness is prevented from slipping and is nevertheless flexible.

There are other embodiments in which more than one strip of the covering material has been applied on the adhesive coating. When mention is made of only one strip, the person skilled in the art will understand that it is also fully possible that a plurality of strips simultaneously cover the adhesive coating.

The production and processing of the adhesives can take place from solution or dispersion, or else from the melt. Preferred methods of production and processing take place from solution or else from the melt. Particular preference is given to manufacture of the adhesive from the melt, and it is in particular possible here to use batch processes or continuous processes. Continuous manufacture of the pressure-sensitive adhesives with the aid of an extruder is particularly advantageous.

The resultant adhesives can then be applied to the carrier by the well-known processes. In the case of processing from the melt, the application process here can use a die or a calender.

In the case of processes from solution, known coatings are those using doctors, blades or dies, to mention just a few.

Another possibility is transfer of the adhesive to the carrier composite from an antiadhesive carrier blanket or release liner.

Finally, the adhesive tape can have a protective covering material which covers the one or two adhesive layer(s) prior to use. Again, any of the materials in the detailed list above is suitable as protective covering material.

However, preference is given to a nonlimiting material, for example a plastics film or a well sized, long-fiber paper.

A reverse-side lacquer can have been applied to the reverse side of the adhesive tape in order to improve the unwinding properties of the adhesive tape after it has been wound to give an Archimedean spiral. Said reverse-side lacquer can comprise silicone compounds or fluorosilicone compounds, or else polyvinyl stearyl carbamate, polyethyleneimine stearyl carbamide or fluoroorganic compounds as substances with antiadhesive effect. Underneath the reverse-side lacquer, or alternatively thereto, there is optionally a foam coating on the reverse side of the adhesive tape.

The adhesive tape of the invention can be provided in fixed lengths, for example as product supplied by the yard, or else as continuous product on rolls (Archimedean spirals). In the latter case, knives, cutters or dispensers or the like can be used to provide various lengths for use, or the material can be processed manually without aids.

In order to facilitate manual initiation of a tear in the adhesive tape, said tape can moreover have one or more lines of weakness in essence at right angles to the direction of running.

To permit particularly easy use, the orientation of the lines of weakness is at right angles to the direction of running of the adhesive tape and/or the arrangement has said lines at regular distances from one another.

Parting of the adhesive tape is particularly easy if the lines of weakness take the form of perforations.

This method can provide edges that are very free from lint between the individual sections, thus avoiding undesired fraying.

The lines of weakness can particularly advantageously be produced batchwise by use of flat dies or cross-running perforator wheels, or continuously by use of rotary systems such as spiked rolls or punch rolls, optionally with use of a counter roller (Vulkollan roll) forming the contour wheel during the cutting process.

Other possibilities are provided by cutting technologies using controlled intermittent operation, examples being lasers, ultrasound, high-pressure water jets, etc. If in the case of laser cutting or ultrasound cutting some of the energy is introduced in the form of heat into the carrier material, it is possible to fuse the fibers in the region of cutting in a manner that very substantially avoids problematic fraying and gives clean cut edges. The latter processes are also suitable for achieving specific cut-edge geometries, for example cut edges of concave or convex shape.

The height of the spikes or blades on the punch rolls is preferably 150% of the thickness of the adhesive tape.

In the case of perforation, the hole-to-fillet ratio, i.e. the number of millimeters holding the material together (“bridge”), and the size of the perforations in millimeters, determines how easy it is in particular to initiate a tear in the fibers of the carrier material. This ratio moreover also finally influences the extent to which the torn edge can be obtained lint-free.

Fillet width is preferably about 2 mm, and the cut width between the fillets is preferably about 10 mm, i.e. cut width between the fillets is preferably about 10 mm, i.e. fillets of width 2 mm alternate with incisions measuring 10 mm. The hole-to-fillet ratio is accordingly preferably 10:2.

This weakening of the material permits achievement of a sufficiently low tear force.

If low flammability of the adhesive tape described is desired, this can be achieved by adding flame retardants to the carrier and/or to the adhesive. These can be organobromine compounds, if necessary with synergists such as antimony trioxide, but with a view to absence of halogen in the adhesive tape it is preferable to use red phosphorus, or organophosphorus, or mineral or intumescent compounds, for example ammonium polyphosphate alone or in combination with synergists.

In a preferred embodiment, the width of the adhesive tape is from 9 to 38 mm.

For the purposes of this invention the general expression “adhesive tape” comprises all sheet products, for example two-dimensional films or film sections, elongate tapes with restricted width, tape sections and the like, and finally also punched-out products or labels.

It is moreover advantageously suitable for the wrapping of elongate target material, for example cable harnesses in motor vehicles, where the adhesive tape is passed in a helical line around the elongate target material or the elongate target material can be wrapped in axial direction by the tape.

Finally, the concept of the invention also comprises an elongate target material wrapped with an adhesive tape of the invention. The elongate target material is preferably a cable harness.

By virtue of the excellent suitability of the adhesive tape, it can be used in wrapping that is composed of a covering material where, at least in an edge region of the covering material, the self-adhesive tape present has been adhesive-bonded on the covering material in such a way that the adhesive tape extends over one of the longitudinal edges of the covering material, and specifically preferably in an edge region that is narrow in comparison with the width of the covering material.

EP 1 312 097 A1 discloses a product of this type, and also optimized embodiments of same. EP 1 300 452 A2, DE 102 29 527 A1 and WO 2006 108 871 A1 describe further developments for which the adhesive tape of the invention likewise has very good suitability. The adhesive tape of the invention can equally be used in a process disclosed in EP 1 367 608 A2.

Finally, EP 1 315 781 A1 and DE 103 29 994 A1 describe embodiments of adhesive tapes that are also possible for the adhesive tape of the invention.

Finally, the concept of the invention also comprises an elongate target material wrapped with an adhesive tape of the invention. The elongate target material is preferably a cable harness, more preferably in an automobile.

The invention moreover provides the use of the film of the invention as carrier, carrier in adhesive tapes and/or in cable-wrapping tapes, carrier in cable tapes in accordance with LV 312, carrier for adhesive, carrier for pressure-sensitive adhesives, carrier in items for the identification-marking of articles and of components, in particular in vehicles and for identification-marking of electrical devices, carrier in multilayer labels and diecuts ord in multilayer laser-inscribable labels and diecuts or transfer material or as transfer film or release liner or OLED or in adhesive tapes as outer material, outer film, transfer material and/or release liner.

In the inventive use it is preferable to use a carrier which has high softness, high thermal stability and an excellent degree of crystallization, and in which no migration of the compounds present, in particular of the plasticizer, takes place. It is preferable in the inventive use to use a carrier comprising the formulation A and obtainable by the process of the invention.

The present invention particularly provides excellent suitability of the film of the invention for adhesives and pressure-sensitive adhesives, and in particular provides the combination of the film of the invention with the abovementioned biobased pressure-sensitive adhesive.

The invention further provides a film structure and, respectively a film arrangement which comprises at least one film of the invention. The at least one film is preferably produced by the process of the invention from formulation A and/or B. The properties of the respective films can differ in respect of degree of crystallization, thermal stability and softness within ranges defined herein. The combined films can moreover have different layer thicknesses of from 5 μm to 500 μm, preferably from 5 μm to 50 μm, or from 10 μm to 40 μm, particularly preferably from 15 μm to 30 μm. There can be a plurality of films of different layer thickness arranged in the form of a plurality of mutually superposed layers: it can be advantageous for the stability and/or flexibility of the film arrangement of the invention to combine films of different layer thickness (for example 5 μm, 10 μm, 15 μm, 20 μm, 30 μm and/or 40 μm). In particular, films of different layer thickness with different degrees of orientation can be combined: a film can have a layer thickness of from 10 μm, 15 μm, 20 μm or 25 μm to 30 μm, 35 μm or 40 μm and a degree of orientation with a factor A of from 1, 2, 3, 4, 5 or 6 to 7, and can provide a film arrangement of by way of example 2, 3, 4 or 5 film layers.

There is therefore a possible film arrangement which has a plurality of layers, in particular 3, 4 or 5, where at least one of the exposed (externally arranged) layers has relatively high thermal stability whereas the internally situated layers have relatively low thermal stability. It is likewise possible that one or both exposed layers have relatively low softness (a relatively low proportion of plasticizers) whereas the internally situated film layers in contrast have relatively high softness (a higher proportion of plasticizers) for better flexibility. Films of different degrees of crystallization, which can be combined in the film arrangement, can be produced by varying the proportion of nucleating agent.

### EXAMPLES

Glass Transition Temperatures T_{G}

Glass transition temperatures T_{G} were determined by dynamic mechanical analysis (DMA), using the following parameters: glass transition temperatures were determined by means of temperature sweep. All data in this document are based on the results of these measurements unless otherwise stated in a particular case. DMA makes use of the fact that the properties of viscoelastic materials subjected to a sinusoidal mechanical stress are dependent on the frequency of the stress (i.e. on the time) as well as on the temperature.

Dma Parameters:

Measurement equipment: Scientific RDA III; measurement head: spring-mounted with standard force; temperature control: heating chamber; measurement geometry: parallel-plate arrangements, sample thickness 1 (±0.1) mm; sample diameter 25 mm (a sample of thickness 1 mm was produced by laminating five layers (respectively 200 μm) of the appropriate adhesive tape to one another; the PET carrier makes no significant contribution to rheological properties, and its presence can therefore be ignored.

The films produced in this way exhibit not only high transparency but also no migration and a high proportion of renewable raw materials (up to 99%). They can moreover achieve high elongation (>250% with A=1), high strengths (with λ=from 5 to 6) and high thermal stability (shrinkage at 120° C. 5%).

Molecular Weight M_{w}

Average molecular weight M_{w} and polydispersity D were determined by gel permeation chromatography (GPC). THF with 0.1% by volume of trifluoroacetic acid was used as eluent. Measurement temperature was 25° C. The precolumn used was a PSS-SDV, 5 μm, 10³ Å, ID 8.0 mm×50 mm. The separation columns used were PSS-SDV, 5 μm, 10³ Å, 10⁵ Å and 10⁶ Å with respectively ID 8.0 mm×300 mm. Sample concentration was 4 g/I, and flow rate was 1.0 ml per minute. PMMA standards were used.

Average molecular weight M_{w} was determined by gel permeation chromatography (GPC). THF with 0.1% by volume of trifluoroacetic acid was used as eluent. Measurement temperature was 25° C. The precolumn used was a PSS-SDV, 5 μm, 10³ Å, ID 8.0 mm×50 mm. The separation columns used were PSS-SDV, 5 μm, 10³ Å, 10⁵ Å and 10⁶ Å with respectively ID 8.0 mm×300 mm. Sample concentration was 4 g/I, and flow rate was 1.0 ml per minute. PMMA standards were used. (μ=μm; 1 Å=10⁻¹⁰ m).

Example of the Process for the Production of a Formulation B:

Ingeo 4032D PLA granulate from NatureWorks was melted at a temperature of 180° C. in a twin-screw extruder. The plasticizer triethyl citrate (Citrofol Al from Jungsbunzlauer) at a concentration of from 1% by weight to 20% by weight, particularly from 11% by weight to 13% by weight, specifically 12% by weight, and the nucleating agent at a concentration of from 0.1% by weight to 5% by weight, particularly 0.5% by weight to 3% by weight, specifically 2% by weight, were incorporated into the PLA here. The resultant strand of material (formulation B) was cooled in a water bath and granulated (formulation B).

Example of the Process for the Production of a Film of the Invention:

The formulation B is melted in a single-screw extruder at temperatures of from 170 to 190° C., particularly 180° C., which was selected here, shaped with the aid of a flat-film die, and cooled on a chill roll at temperatures of from 20 to 60° C., particularly 40° C., which was selected here. The film is then longitudinally oriented in the stretching unit at temperatures above the Tg, particularly from 90 to 120° C., more preferably 110° C., which was selected here, by factors of from A=1 to A=7, particularly from A=1 or A=5 to 6 (5.5 being selected here).

Properties of films of the invention

| | | | Function of | Measurement |
|---|---|---|---|---|
| Parameter | Minimum | Maximum | parameter | method used |
| Enthalpy of | 30 [J/g] | 50 [J/g] | Degree of | DIN EN ISO |
| fusion | | | crystallization | 11357-3 |
| Shrinkage | 0% | 5% | Thermal | DIN 53377 |
| | | | stability | |
| Migration | No | Yes | Migration | |
| Tensile strain | 3% | 300% | Softness | ISO 527 |
| at break | | | | |

1. A biobased film comprising a composition based on polylactic acid comprising the following components
(a) at least one biobased (co)polymer based on at least one lactic acid derivative,
(b) at least one plasticizer comprising at least one compound comprising an ester group, with the exception of dimeric and polymeric esters of lactic acid,
(c) at least one nucleating agent, and
(d) optional additives.

2. The film as claimed in claim 1, wherein the proportion present of each component, based on the entire content of the composition, is
(a) from 75% by weight to 98.9% by weight of the at least one biobased (co)polymer based on at least one lactic acid derivative,
(b) from 1% by weight to 20% by weight of the at least one plasticizer,
(c) from 0.1% by weight to 5% by weight of the at least one nucleating agent, and
(d) from 0% by weight to 20% by weight of additives.

3. The film as claimed in claim 1, wherein its transparency is from 80% to 100%, measured by means of transmission at a wavelength of from 400 nm to 800 nm, and/or its thermal stability, measured as shrinkage in accordance with DIN 53377, is from 0% to 5%, and/or its softness, measured as tensile strain at break (in accordance with ISO 527), is from 3% to 300%.

4. (canceled)

5. (canceled)

6. A process for the production of the film as claimed in claim 1, the process comprising steps 1 through 3 in order:
pstep 1: mixing (a) through (c) to produce a formulation A
(a) at least one biobased (co)polymer based on at least one lactic acid derivative,
(b) at least one plasticizer comprising at least one compound comprising an ester group, with the exception of dimeric and polymeric esters of lactic acid, and
(c) at least one nucleating agent,
step 2: producing a formulation B by introduction of heat, and
step 3: molding the film is molded.

7. The process as claimed in claim 6, wherein
in step 2 formulation B is obtained by melting of formulation A,
in a optional step 2A subsequent to step 2 and before step 3, formulation
B is cooled.

8. The process as claimed in claim 6, wherein
in step 2 the molten formulation B is granulated, and
in step 3 the film made of the granulate of the formulation B is molded.

9. The process as claimed in claim 6, further comprising
step 4: the film from step 3 is longitudinally oriented at a temperature above the T_{G} by a factor λ of from 1 to 7.

10. A film produced by the process as claimed in claim 6.

11. A formulation A comprising polylactic acid comprising the following components
(a) at least one biobased (co)polymer based on at least one lactic acid derivative,
(b) at least one plasticizer comprising at least one compound comprising an ester group, with the exception of dimeric and polymeric esters of lactic acid,
(c) at least one nucleating agent, and
(d) optional additives.

12. The formulation A as claimed in claim 1, wherein the proportion present of each component, based on the entire content of the composition, is
(a) from 60% by weight to 98.9% by weight of the at least one biobased (co)polymer based on at least one lactic acid derivative,
(b) from 1% by weight to 20% by weight of the at least one plasticizer,
(c) from 0.1% by weight to 5% by weight of the at least one nucleating agent, and
(d) from 0% by weight to 15% by weight of additives.

13. The formulation A as claimed in claim 11, wherein (a) the at least one lactic acid derivative of the at least one biobased (co)polyester is a monomer and/or dimer selected from the group consisting of L(S)-lactic acid, D(R)-lactic acid (S,S)-lactide, (R,R)-lactide, (meso)lactide, and mixtures of at least two listed compounds.

14. The formulation A as claimed in claim 11, wherein (b) the at least one plasticizer is an ester of a di- or tricarboxylic acid, comprising (i) aliphatic saturated or unsaturated and (ii) aromatic saturated or unsaturated di- and tricarboxylic esters.

15. The formulation A as claimed in claim 11, wherein (c) the at least one nucleating agent is simultaneously a nucleating accelerator, comprising waxes, mineral fillers and/or biobased fillers.

16. The formulation A as claimed in claim 11, wherein (c) the average particle diameter of the at least one nucleating agent comprising wax and mineral and/or biobased fillers is from 0.5 μm to 5 μm.

17. A formulation B produced by the process as claimed in claim 6, wherein its thermal stability, measured as shrinkage (in accordance with DIN 53377), is from 0% to 5%, and/or wherein its degree of crystallization, measured as enthalpy of fusion (in accordance with DIN EN ISO 11357-3), is from 30 J/g to 50 J/g.

18. (canceled)

19. A process for the production of carriers in the form of (a) sheetlike elements comprising sheetlike elements produced by spinning, weaving and/or melting, and/or (b) fiber structures comprising yarns, knits, braids, filaments and fibers produced by spinning, weaving and/or melting and sheetlike elements comprising fiber structures, the process comprising,
providing the formulation B as claimed in claim 17 in the form of a flowable solid material comprising granulates, extrudates, pellets, grains and powders, or in the form of banderoles, strands, product supplied by the yard, slabs and/or sheets.

20. A pressure-sensitive-adhesive sheet product comprising at least one film as claimed in claim 1 and at least one adhesive.

21. (canceled)

22. A pressure-sensitive-adhesive sheet product comprising at least one film produced by the process as claimed in 6 and at least one adhesive.

23. The formulation A as claimed in claim 12, wherein the proportion present of component (a), based on the entire content of the composition, is from 75% by weight to 98.9% by weight of the at least one biobased (co)polymer based on at least one lactic acid derivative.
